(19) United States
(12) Patent Application Publication
(10) Pub. No.: US 2007/0232749 A1
(43) Pub. Date: Oct. 4, 2007

(54) Silicone coating composition for protection from cathodic stress

(75) Inventors: Farooq Ahmed, Guelph (CA); Faisal Huda, Toronto (CA); Seraj ul Huda, Toronto (CA); John Barr, Eden Mills (CA)

Correspondence Address: Dennison Associates, Suite 301, 133 Richmond Street West, Toronto, ON, M5H 2L7, CA

(73) Assignee: CSL Silicones Inc.

(21) Appl. No.: 11/375,211

(22) Filed: Mar. 15, 2006

(51) Int. Cl. C08L 83/04; B05D 3/00; B32B 27/00

(52) U.S. Cl. 524/588; 427/387

(57) ABSTRACT

This invention relates to a corrosion protection silicone coating system provides for easy and convenient application by conventional methods such as dipping, brushing or spraying. The coating provides a guard against environmental effects causing cathodic stress along with high physical strength and adhesion achieved with a suitable blend of reinforcing and extending fillers. The coating is an organopolysiloxane rubber coating composition containing between about 10 and 80 weight percent of a sacrificial metal filler to provide protection against environmental effects causing cathodic stress. Preferably, the coating is a one-part room temperature vulcanizing organopolysiloxane rubber coating composition to provide protection against cathodic stress. The present invention also provides for a method of coating metal surfaces to protect the metal surface from corrosion and cathodic stress. The method comprises applying to the surface a thin layer of the above one-part organopolysiloxane rubber composition and allowing the layer of the one-part organopolysiloxane rubber composition to cure at room temperature to a silicone elastomer.

### FIELD OF THE INVENTION

The present invention is directed to a silicone coating composition which protects metal surfaces from corrosion and cathodic stress.

### BACKGROUND OF THE INVENTION

A common coating is one which is used to protect metal surfaces against corrosion, especially that caused by cathodic stress. Corrosion is an electrochemical process that causes degradation of metal by an oxidative process. Environmental factors such as water, oxygen, salt and acid rain cause oxidative chemical reactions that slowly convert the metal into metal oxide and wear it off from the surface. Coatings provide a barrier between the metal and the environmental factors that cause corrosion. The efficiency of the coating and its service life depends on its barrier properties against penetration of moisture and other chemicals and its resistance to degradation caused by environmental factors such as salt, acid rain and Ultra Violet (UV) radiation. The coating integrity may also be affected by mechanical damage which exposes the metal to the environment and initiates electrochemical oxidation of the metal and subsequent delamination of the coating. Sacrificial metals such as zinc, nickel and aluminum in the coating provide relief against cathodic stress caused by contact of moisture, salt and oxygen to the exposed metal.

Most of the coating systems presently available provide cathodic protection to the substrate by a three coat system. The first coat contains a sacrificial metal (metal rich coat) followed by second coat which helps to bind the base and top coat together and also helps to seal the sacrificial metal and finally a third organic coat to provide a barrier between the external environment and the base coat. Examples of three coat systems are three coat epoxy or polyurethane systems shown for example in U.S. Pat. No. 6,866,941.

Epoxy based compositions utilize a two-part composition which is coated on the surface by brushing, dipping or spraying. Epoxy based coating compositions have the advantage of providing a coating with a high-gloss surface. However the epoxy based coatings generally require that the two separate parts be mixed together and used within a very short period of time. If the composition is not utilized with this period of time, it will cure before it can be applied to the surface. In addition, epoxy based compositions may emit volatile organic compounds (VOC) and require care in handling.

There still remains a need for a coating which provides protection from cathodic stress, a barrier against moisture and chemicals for corrosion protection and UV resistance in a single-coat, primer less system.

### SUMMARY OF THE INVENTION

This invention relates to a corrosion protection silicone coating system that provides protection to a substrate from cathodic stress caused by a corrosive environment and has longer service life by virtue of its resistance against environmental factors such as chemicals, heat and UV radiation.

The coating provides for easy and convenient application by conventional methods such as dipping, brushing or spraying. The coating provides a guard against environmental effects causing cathodic stress along with high physical strength and adhesion achieved with a suitable blend of reinforcing and extending fillers.

The present invention provides an organopolysiloxane rubber coating composition containing between about 10 and 80 weight percent of a sacrificial metal filler to provide protection against environmental effects causing cathodic stress.

In an aspect of the invention, the coating composition comprises:
a) from about 5 to about 80 weight percent of one or more polyorganosiloxane fluids of the formula:
   R¹[(R)₂SiO]n(R)₂Si R¹
in which R is a monovalent alkyl or alkenyl radical having 1 to 8 carbon atoms or a phenyl radical, R¹ each of which may be the same or different are OH, a monovalent alkyl or alkenyl radical having 1 to 8 carbon atoms or a phenyl radical, and n has an average value such that the viscosity is from about 10 to about 100,000 centipoise at 25° C. preferably from about 500 to about 20,000 centipoise at 25° C. In at least one of the polyorganosiloxane fluids the R¹ is a reactive group such as OH or alkenyl, preferably OH, most preferably both R¹ are OH.
b) from about 10 to about 80 weight percent of a sacrificial metal filler;
c) from about 0 to about 15 weight percent of a conductive filler;
d) a suitable catalyst for the reactive group of the polyorganosiloxane of (a); and
e) a suitable cross linking agent for the reactive group of the polyorganosiloxane of (a).

In another aspect, the present invention provides for a one-part room temperature vulcanizing organopolysiloxane rubber coating composition to provide protection against cathodic stress. The composition consists essentially of the product which is obtained by mixing the following:
a) from about 5 to about 80 weight percent of one or more polydiorganosiloxane fluids of the formula:
   HO[ (R¹⁷)₂SiO]ₙ(R¹⁷)₂SiOH
in which R¹⁷ is a monovalent alkyl or alkenyl radical having 1 to 8 carbon atoms or a phenyl radical which may contain 3 to 9 halogen atoms, and n has an average value such that the viscosity is from about 10 to about 100,000 centipoise at 25° C., preferably from about 500 to about 20,000 centipoise at 25° C.;
b) from 0 to about 8 weight percent of a bifunctional chain extender of the general formula:
   R¹⁸₂—Si—X¹₂
where X¹ is an alkyl radical with a functional group linked directly to the silicon atom, preferably carboxyl, ketoximino, alkoxy, carbonyl or amine, most preferably alkoxy or ketoximino and R¹⁸ is a monovalent alkyl or alkenyl radical having 1 to 8 carbon atoms or a phenyl radical;
c) from about 10 to about 80 weight percent of one or more sacrificial metal fillers;
d) from about 0 to about 15 weight percent of one or more conductive fillers;
e) from about 0 to about 20 weight percent of an optionally surface treated amorphous SiO₂ reinforcing filler having a surface area of between about 50 to 250 m²/g and a particle size range between about 0.01 and 0.03 microns;
f) from about 0.1 to about 35 weight percent of one or more crosslinking agents of general formula:
   (X)₄₋ₘ—Si—R¹²ₘ
where R¹² is an alkyl, alkenyl, or phenyl radical (preferably methyl or ethyl), X is an alkyl radical with a functional group selected from carboxyl, ketoximino, alkoxy, carbonyl or amine linked directly to the silicone atom, and m is an integer of from 0 to 2;
g) from about 0.2 to about 3 weight percent of an adhesion promoter of the formula: 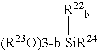
in which R²² and R²³ are independently selected from monovalent alkyl or alkenyl radicals having 1 to 8 carbon atoms or a phenyl radical which may optionally be substituted with an alkyl radical having 1 to 8 carbon atoms and may also contain 3 to 9 halogen atoms, b is an integer between 0 and 3, and R²⁴ is a saturated, unsaturated or aromatic hydrocarbon radical having 1 to 10 carbon atoms which may optionally contain an organo-functional group;
h) from about 0 to about 5 weight percent of an organometalic complex as a condensation catalyst of the formula:
   (R²⁵)₂M(R²⁶)₂

where R²⁵ is a monovalent alkyl, alkenyl radical having 1 to 10 carbon atoms or phenyl radical R²⁶ is an alkyl, alkenyl radical having 1 to 10 carbon or phenyl radical having an organo-functional group and M is a metal; and
i) from 0 to 80 weight percent of a suitable solvent or diluent.

The present invention also provides for a method of coating metal surfaces to protect the metal surface from corrosion and cathodic stress. The method comprises applying to the surface a layer an organopolysiloxane rubber composition containing from about 10 to about 80 weight percent of a sacrificial metal filler and allowing the layer of the one-part organopolysiloxane rubber composition to cure at room temperature to a silicone elastomer.

### DETAILED DESCRIPTION OF THE INVENTION

The organopolysiloxane rubber compositions of the present invention containing sacrificial metal filler are ideally suited for protection of surfaces from environmental effects. Such protection includes, in particular cathodic stress caused by exposure of metal surfaces and structures against salt spray and chemical environments including direct exposure to salt water, salt fog, gases and other industrial pollutants. The contact between two dissimilar metals may also cause cathodic stress especially in the presence of moisture. The compositions of the present invention can also be used to coat metal surfaces of motor vehicles which may be exposed to high salt condition during the winter season. The compositions with suitable additives also provide protection against the effects of weathering from exposure to among others UV radiation. The compositions of the present invention are particularly useful on marine installations, such as coatings of ship hulls, oil rigs, docks, piers, buoys, water intake pipes and various submerged structures. The coating composition of the present invention is also useful for coating electric transmission towers and bridges for cathodic stress protection of metal structures directly exposed to salt water and industrial pollution, especially sulfur based air pollutants.

Because it is made of silicone, the resulting coating on the metal surface provides protection against the otherwise damaging effects of environmental weathering, UV exposure, hydrolysis, and other effects. Because of its naturally hydrophobic nature, the external layer of silicone creates a highly hydrophobic coating of very low cost.

The composition utilized in the present invention comprises a vulcanizable polyorganosiloxane and sacrificial metal filler which provides the composition with its corrosion protection particularly against cathodic stress.

The vulcanizable polyorganosiloxane may be any of the commonly utilized vulcanizing polyorganosiloxane compositions utilizing one part or two part systems cured catalytically, for example through addition curing, or utilizing moisture curing systems. The polyorganosiloxane is terminated with a reactive group, generally hydroxyl or alkenyl as follows:
R¹[(R)₂SiO]n(R)₂Si R¹

in which R is a monovalent alkyl or alkenyl radical having 1 to 8 carbon atoms or a phenyl radical, R¹ each of which may be the same or different is a reactive group selected from OH, or a monovalent alkenyl radical having 1 to 8 carbon atoms, and n has an average value such that the viscosity is from about 10 to about 100,000 centipoise at 25° C. preferably from about 500 to about 20,000 centipoise at 25° C.

Catalytically polymerizable polyorganosiloxane compositions using addition cure systems are not controlled by moisture of the atmosphere. High temperature can accelerate the curing process although the crosslinking addition reaction may also occur at room temperature. The base polymer is generally a polydiorganosiloxane of general formula:
R³[(R²)₂SiO]n(R²)₂ Si R³

where R² is a monovalent alkyl or alkenyl radical having 1 to 8 carbon atoms, optionally substituted with 1 to 9 halogen atoms, or a phenyl radical, optionally substituted with 1 to 6 halogen atoms, R³ is monovalent alkenyl radical (preferably a monovalent vinyl or ethylene radical) and n has an average value such that the viscosity is from 100 to 100,000 centipoise. An example of such a base polymer is:
CH₂═CH—Si(CH₃)₂—O—Si(CH₃)₂—O - - - O—Si(CH₃)₂—CH═CH₂

The addition cure systems utilize a crosslinker to polymerize the base polymer. The crosslinker is generally a polydiorganosiloxane of general formula:
R⁵[(R⁴)(H)SiO]ₘ[(R⁴)₂SiO]ₙR⁵

where each R⁴ and R⁵ which may be the same or different is a monovalent alkyl or alkenyl radical having 1 to 8 carbon atoms, optionally substituted with 1 to 9 halogen atoms, or phenyl radical, optionally substituted with 1 to 6 halogen atoms and H is hydride radical, m and n are integers and their total average value is such that the viscosity is from 10 to 10,000 centipoise. The value of m is 10 to 50 percent of the value of m+n.

For optimum crosslinking the ratio of the alkenyl radical, preferably ethylene radical, to hydride radical is from 1:1 to 6:1.

The crosslinking reaction of addition cure systems requires a catalyst, generally an organometallic complex of Platinum of the formula:
Pt[R⁷(SiOR⁶)R⁷]₄

In which R⁶ is alkyl or alkenyl and R⁷ is alkenyl. An example of such a platinum catalyst is:

Platinum Divinyltetramethyldisiloxane complex
(CH₂═CH—Si(CH₃)₂—O—Si(CH₃)₂—CH═CH₂)₄Pt

Crosslinking by addition is an extremely fast reaction. The reaction speed can be controlled by reducing the amount of catalyst or by using a reaction inhibitor such as a vinyl terminated dimethylsiloxane that reduces the activity of the platinum catalyst.

An adhesion promoter may also be used for two-part addition cure system to improve the adhesion of the elastomer to the surface. The adhesion promoter is generally a silane having general formula:
R⁸Si(R⁹O)₃

where R⁸ is an alkenyl radical, preferably a vinyl radical, and R⁹ is an alkyl radical having 1 to 6 carbon atoms.

Addition cure systems are generally provided in two-parts with the base polymer, crosslinker, adhesion promoter and inhibitor in one part and base polymer and catalyst in the other part. Fillers and pigment are added in either part to achieve equivalent viscosity of both parts for homogenous mixing.

Crosslinking of polyorganosiloxane terminated by alkenyl radical such as vinyl radical (also described for addition cure system) can also be accelerated by heat in presence of organic peroxide such as dichlorobenzoyl peroxide, trichlorobenzoyl peroxide or dicumyl peroxide as catalyst. Crosslinking by organic peroxide does not require hydride functional crosslinker (as described in addition cure system).

Moisture curing systems are generally room temperature vulcanizable (RTV), although higher temperatures may be employed to accelerate the curing reaction. The moisture curing composition may be provided as a two part system similar to the addition cure compositions or may be a one part composition containing all of the components of the composition in a single container. Preferably for ease of handling and application, the RTV compositions are in one part.

Moisture cure systems generally utilize a hydroxyl terminated polyorganosiloxane as a base polymer. Preferably, the base polymer is one or more polyorganosiloxanes of the general formula:
R¹¹[(R¹⁰)₂SiO]n(R¹⁰)₂SiR¹¹

in which R¹⁰ is a monovalent alkyl or alkenyl radical having 1 to 8 carbon atoms or a phenyl radical, R¹¹ each of which may be the same or different are OH, a monovalent alkyl or alkenyl radical having 1 to 8 carbon atoms or a phenyl radical, and n has an average value such that the viscosity is from about 10 to about 100,000 centipoise at 25° C. preferably from about 500 to about 20,000 centipoise at 25° C. At least one of the R¹¹ has a reactive group such as OH or alkenyl, preferably OH, most preferably both R¹¹ are OH.

The moisture curing systems utilize a crosslinker having the general formula:
(X)₄₋ₘ—Si—R¹²ₘ

where R¹² is an alkyl, alkenyl or phenyl radical (preferably methyl or ethyl) and X an alkyl radical with a functional group linked directly to silicone atom and m is an integer of from 0 to 2. The functional group can be carboxyl, ketoximino, alkoxy, carbonyl or amine.

The commonly employed cross linkers for moisture cure RTV One-Part or Two-Part Systems include:

Acetoxy Silane (CH₃C(O)O)₃—Si—R¹² Releases Acetic Acid as curing by-product.

Oxime Silane (C₂H₅(CH₃)C═NO)₃—Si—R¹² Releases methylethyl ketoxime as curing by-product.

Alkoxy Silane (R¹³O)₃—Si—R¹² Where R¹³ is an alkyl radical from 1 to 6 carbon. It releases alcohol as curing by-product.

Enoxy Silane (CH₃C(O)CH₂)₃—Si—R¹² Releases Acetone as curing by-product.

Amine Silane ((CH₃)₂N)₃—Si—R¹² Releases Amine as curing by-product. It is the fastest reacting crosslinker that does not require a catalyst.

To improve the crosslinking reaction, a catalyst is generally utilized. For moisture cure systems, one commonly employed catalyst is an organotin salt such as dibutyl tin dilaurate, among others.

To improve the adhesion of the elastomer to the surface on which it is coated, an adhesion promoter may be employed. The adhesion promoter is commonly a compound of the formula:

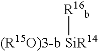

in which R¹⁵ and R¹⁶ are independently selected from monovalent alkyl or alkenyl radicals having 1 to 8 carbon atoms or a phenyl radical which may optionally be substituted with an alkyl radical having 1 to 8 carbon atoms, b is an integer between 0 and 3, and R¹⁴ is a saturated, unsaturated or aromatic hydrocarbon radical having 1 to 10 carbon atoms which may optionally contain a functional group.

The one-part organopolysiloxane rubber compositions of the present invention for use as a protective coating contain about 5 to about 80 weight percent of one or more polydiorganosiloxane fluids of the formula:
HO[(R¹⁷)₂SiO]ₙ(R¹⁷)₂SiOH

in which R¹⁷ is a monovalent alkyl or alkenyl radical having 1 to 8 carbon atoms or a phenyl radical which may contain 3 to 9 halogen atoms, and n has an average value such that the viscosity is from about 10 to about 100,000 centipoise at 25° C. Preferably n has an average value such that the viscosity is between about 500 and about 20,000 centipoise at 25° C., more preferably between about 1,000 and about 20,000 centipoise at 25° C.

Polydimethylsiloxane is the most preferred silicone polymer fluid. The polydimethylsiloxanes may contain small amounts of monomethylsiloxane units and methyl radical replaced with other radicals in small amounts as impurities such as is found in commercial products, but the preferred fluid contains only polydimethylsiloxane. When using low viscosity fluids, generally 1,000 centipoise or less, it may be advantageous to add bifunctional chain extenders of the general formula:
R¹⁸₂—Si—X¹₂

where X¹ is an alkyl radical with a functional group linked directly to the silicon atom, preferably alkoxyl, ketoximino, carbonyl, carboxyl or amine, most preferably alkoxy or ketoximino and R¹⁸ is a monovalent alkyl or alkenyl radical having 1 to 8 carbon atoms or a phenyl radical. If chain extenders are utilized they are generally present in an amount of up to about 8 weight percent, preferably between about 2 weight percent and about 8 weight percent.

The composition of this preferred embodiment may contain a second linear dimethyl polysiloxane of low molecular weight to act as a viscosity reducer diluent for the composition for ease in applying the composition to the surface. The low molecular weight linear dimethyl polysiloxanes are end blocked oligomeric compounds of the above formula where the terminal —OH are replaced by blocking groups which may be the same or different, are independently selected from a monovalent alkyl or alkenyl radical having 1 to 8 carbon atoms or phenyl radical. The average value of n ranges between 4 and 24, preferably between 4 and 20.

If the composition contains the two different polysiloxanes set out above, the total of the polysiloxanes is generally about 40 to 60 weight percent with the relative amounts of the two polysiloxanes being selected based upon the desired characteristics of the final coating. Generally each of the polysiloxanes will be present in a ratio of from about 30 weight percent to about 70 weight percent based upon the total weight of the polysiloxane fluids.

In addition to, or in place of the low molecular weight linear dimethyl polysiloxanes, the composition may contain up to about 40 weight percent, more preferably 20 to 30 weight percent of a cyclo-organosiloxane of the formula:
[(R¹⁹)₂SiO]n

in which R¹⁹ is a monovalent alkyl or alkenyl radical having 1 to 8 carbon atoms or a phenyl radical which may optionally be substituted with an alkyl radical having 1 to 8 carbon atoms and n has an average value of 3 to 10. The preferred cycloorganosiloxane is a cyclic dimethylsiloxane and is used in a similar manner to the low molecular weight linear dimethyl polysiloxanes as a diluent to lower the viscosity of the composition for convenient application by spraying, brushing or dipping.

The composition also contains 10 to 80 weight percent, preferably 30 to 60 weight percent, more preferably 40 to 50 weight percent, of sacrificial metal fillers to increase the resistance of the coating to cathodic stress from environmental effects. The sacrificial metal fillers are preferably selected from zinc powder, zinc flakes, aluminum powder, aluminum flakes, nickel powder, nickel flakes, magnesium powder and magnesium flakes.

In addition to sacrificial filler the composition may also contain from 0 to 15 weight percent of a conductive filler selected from conductive metal powder, metal coated glass fibers or powder, and mica.

The composition may also contain about 0 to 20 weight percent of an amorphous SiO₂ reinforcing filler having a surface area of between about 50 and about 250 m²/g and a particle size range between about 0.01 and 0.03 microns. Preferably the surface area is between about 50 and about 150 m²/g, more preferably between about 75 and about 150 m²/g. The specific gravity of the filler is preferably about 2.2. The surface of the amorphous silica may also be treated with organic molecules such as hexamethyldisilazane or polydimethylsiloxane or silane. It has been found that using a surface treated silica helps reduce the viscosity of the composition. Similarly the use of lower surface area fillers also aids in reducing viscosity of the composition.

The composition also contains about 0.1 to about 35 weight percent, preferably about 3 to about 15 weight percent, more preferably about 3 to about 10 weight percent of an organofunctional cross-linking agent of general formula:
(X)₄₋ₘ—Si—R¹²ₘ

where R¹² is an alkyl, alkenyl or phenyl radical (preferably methyl or ethyl), X is an alkyl radical with a functional group selected from carboxyl, ketoximino, alkoxy, carbonyl or amine linked directly to the silicone atom, and m is an integer of from 0 to 2. Preferably the cross linking agent is an oximinosilane cross linking agent of the formula R²⁰Si(ON═CR²¹₂)₃ in which R²⁰ and R²¹ each represent a monovalent alkyl or alkenyl radical having 1 to 8 carbon atoms or a phenyl radical, preferably an alkyl radical such as methyl, ethyl, propyl, butyl, or an alkenyl radical such as vinyl, allyl, or a phenyl radical. The preferred R²⁰ and R²¹ are alkyl or vinyl radicals, most preferably methyl and ethyl radicals.

The composition also contains about 0.2 to about 3 weight percent of an organo functional silane as an adhesion promoter. Preferably the organo functional silane has the formula:

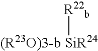

wherein R²² and R²³ are independently selected from monovalent alkyl or alkenyl radicals being 1 to 8 carbon atoms or a phenyl radical which optionally may be substituted with alkyl radicals having 1 to 8 carbon atoms and contain 3 to 9 halogen atoms, b is an integer from 0 to 3, preferably 0, and R²⁴ is a saturated, unsaturated or aromatic hydrocarbon radical being 1 to 10 carbon atoms, which may be further functionalized by a member selected from the group consisting of amino, ether, epoxy, isocyanate, cyano, acryloxy and acyloxy and combinations thereof. R²² and R²³ are preferably an alkyl radical such as, for example, methyl, ethyl, propyl, butyl, or an alkenyl radical such as vinyl and allyl. More preferably R²² and R²³ are alkyl radicals, most preferably methyl, ethyl or propyl radicals. Preferably R²⁴ is an alkyl group, more preferably further functionalized by one or more amino groups. The most preferred organo-functional silane is N-(2-aminoethyl-3-aminopropyl)trimethoxysilane.

The composition additionally contains from about 0 to about 5 weight percent of an organometalic complex as a condensation catalyst which accelerates the aging of the composition. The condensation catalyst is of the formula:
(R²⁵)₂M(R²⁶)₂

where R²⁵ is monovalent alkyl or alkenyl radical having 1 to 10 carbon atoms or a phenyl radical, R²⁶ is an alkyl or alkenyl radical having 1 to 10 carbon or a phenyl radical having an organo-functional group and M is a metal. Preferably the organometalic complex is an organotin complex of a carboxylic acid selected from the group consisting of dibutyltindiacetate, stannous octoate, dibutyltin dioctoate and dibutyltin dilaurate. Preferably the condensation catalyst is present from about 0.02 to about 3 weight percent. Most preferably the organotin salt is dibutyltin dilaurate of the formula:
(C₄H₉)₂Sn(OCOC₁₀H₂₀CH₃)₂.

In all of the above compounds, the alkyl includes straight, branched or cyclic radicals. Among the alkyl groups are C₁₋₁₀ straight or branched-chain alkyl such as, for example, methyl, ethyl, propyl, isopropyl, n-butyl, isobutyl, tert-butyl, pentyl, isopentyl, hexyl, etc., the cycloalkyl are C₃₋₈ cycloalkyl such as, for example, cyclopropyl, cyclobutyl, cyclohexyl, etc., the alkenyl groups are C₁₋₁₀ alkenyl such as, for example, vinyl and allyl. The above groups as well as the phenyl radicals may be further functionalized by including in the chain or ring structure, as the case may be, a group selected from the class consisting of amino, ether, epoxy, isocyanate, cyano, acryloxy, acyloxy and combinations, so long as the functionalization does not adversely affect the desired properties of the compound.

The composition may contain 0 to 80 weight percent of a solvent or diluent to allow for easier application of the coating. The amount of the solvent will be selected to allow the composition to be applied easily and rapidly to the surface to be coated.

The composition may contain other optional ingredients such as pigments and other fillers in minor amounts provided that the addition of the ingredients does not cause degradation of the desired properties of the cured coating made from the composition.

The organopolysiloxane composition of the present invention is prepared by mixing the ingredients together in the absence of moisture. The silane is moisture sensitive and will undergo cross-linking in the presence of moisture such that the mixture must be essentially absent of free moisture when the silane is added and maintained in a moisture free state until cure is desired.

A preferred method of mixing comprises mixing the polysiloxane fluids with the fillers and pigments. Thereafter, the oximinosilane and organo-functional silane are added and mixed under a nitrogen atmosphere. The organotin salt is added to the mixture along with any solvent or diluent and the mixture is then dispensed in sealed containers for storage prior to use.

The surface to be protected is coated with the composition by conventional methods such as dipping, brushing or spraying. Preferably, the surface to be protected is coated by spraying one or more applications of the composition of the present invention. The composition may be adjusted to the consistency suitable for use in these methods by heating or the addition of a suitable solvent, particularly for spray application.

The thickness of the coating will depend upon the specific requirements of the application and the desired level of protection. The coating preferably has an average thickness of 50 to 1000 microns more preferably, an average thickness of 100 to 750 microns, most preferably about 250 to 500 microns. After the coating is formed on the surface, the surface is exposed to normal atmosphere for cross-linking and cure of the coating.

The improved coating of the present invention is capable of protecting surfaces from environmental effects particularly cathodic stress of metal surfaces as a result of corrosion in the presence of moisture such as rain or fog in combination with contaminated atmospheres, salt spray or fog or direct exposure to salt water.

The improved coating of the present invention is particularly useful for protecting metal surfaces which are directly exposed to salt water. Such surfaces include the hulls of ships and other vessels, oil drilling rigs, harbor and pier structures, etc. When the coating is used on the hulls of ships, further benefits such as fouling resistance in addition to the corrosion protection are achieved. The coating does not allow marine animals, such as barnacles, to easily attach to the surface. Any such animals which attempt to attach to the surface are generally removed from the surface by high pressure washers. Additionally, clean up of the surface is generally accomplished by high pressure wash and/or hand or mechanical wiping and does not require the scraping operations commonly utilized during hull cleaning of ships, or other marine installations. As clean up of surfaces coated with the composition of the present invention is easily accomplished, the composition can also be used as an anti-graffiti coating on surfaces.

The following examples are included to illustrate preferred embodiments of the invention and to demonstrate the usefulness of the coating and are not intended to limit in any way the scope of protection for the invention.

### EXAMPLE 1

A coating composition was prepared by mixing 24 parts by weight of polydimethylsiloxane fluid having viscosity of 5,000 centipoise and 2 parts by weight of surface treated amorphous silica having surface treatment with hexamethyldisilazane and surface area of about 125 m²/g, 10 parts by weight of metal coated glass fibres. Then 3 parts by weight of methyl tris-(methyl ethyl ketoxime)silane and 1 part by weight of N-(2-aminoethyl-3-aminopropyl)trimethoxy silane are added and mixed under nitrogen atmosphere. Then 50 parts by weight of zinc powder were also added and mixed. The coating composition was diluted 10 parts by weight of petroleum naphtha to achieve a viscosity between 3,000 and 4,000 cP. Cured elastomeric coating provides excellent resistance against chemicals, galvanic corrosion, cathodic stress and cathodic delamination.

### EXAMPLE 2

A coating composition was prepared by mixing 24 parts by weight of polydimethylsiloxane fluid having viscosity of 5,000 centipoise and 2 parts by weight of surface treated amorphous silica having surface treatment with hexamethyldisilazane and surface area of about 125 m²/g, 10 parts by weight of aluminum flakes. Then 3 parts by weight of methyl tris-(methyl ethyl ketoxime)silane and 1 part by weight of N-(2-aminoethyl-3-aminopropyl)trimethoxy silane are added and mixed under nitrogen atmosphere. Then 50 parts by weight of zinc flakes were also added and mixed. The coating composition was diluted 10 parts by weight of petroleum naphtha to achieve a viscosity between 3,000 and 4,000 cP. Cured elastomeric coating provides excellent resistance against chemicals, galvanic corrosion, cathodic stress and cathodic delamination.

### Cathodic Disbondment Test (ASTM G8)

Test panels were prepared by applying coating formulation on steel pipes of 21-mm outer diameter, 12 mm inner diameter and 230 mm length. One end of the pipe was sealed with silicone sealant and the pipe was coated up to 160-mm length from sealed end with coating thickness of 500 micron. Electrical contact was applied on the non-coated end by using alligator clips.

Instek Laboratory DC power supply Model PS-3030 was used to supply a constant potential supply to the coated electrodes.

The coated ends of the test panels were suspended into a glass tank of capacity 35 liters. The water into the glass tank was circulated by an Aqua Clear 200 pump.

The electrical circuit was prepared as per circuit diagram in ASTM G8 Method B for more than one specimen.

Magnesium anodes were obtained from Interprovincial Corrosion Control Company Limited, Ontario, Canada. The surfaces of the anodes were cleaned periodically during the test to remove deposition of salts.

Standard Calomel Electrode (Single Cell) was obtained from Corning and used for measuring the electrode potential at each coated electrode.

Chemicals for preparation of electrolyte solution were obtained from Alphachem. Electrolyte solution was prepared by mixing 1 mass percent of sodium chloride, 1 mass percent of sodium sulfate and 1 mass percent of sodium carbonate.

Three coating breaks or “Holidays” were made on the coated test panel along the circumference at 120° angle, 30 mm above the lower end, by drilling through the coating to the metal. The drill (2 mm diameter) was modified by grinding the drill point flat to prevent drilling through the metal.

Three more coating breaks or “Holidays” were made on the upper end of the coated electrode, which was not immersed in the electrolyte. The purpose of non-immersed Holidays was to compare the adhesion loss as result of cathodic stress.

A sheet of high-density polyethylene containing holes for electrodes was mounted on top of the tank. The coated electrodes were passed through the holes and suspended into the electrolyte solution symmetrically in such a way that only the coated end portion was immersed in the solution. Two magnesium electrodes were also inserted through the holes and suspended into the solution at both ends of the tank in order to maintain equal distance from all coated electrodes. A potential of 1.5 volts was applied from the DC Power Supply and current was measured on the Ammeter. The potential of each coated electrode was also measured by the Standard Calomel Electrode and recorded. The test was continued for 30 days.

Cathodic delamination of coating on test panel was only from 0 to 2 mm from holliday. This showed excellent resistance of coating against applied cathodic stress for 30 days.

The compositions of the present invention are useful in many instances where protection of surfaces against environmental effects is desired. These compositions include the composition of the above examples as well as other compositions, the formulation of which is well within the skill of the ordinary workman in the art. The selection of the various components and their proportions would be immediately apparent depending upon the desired properties of the final coating.

While the invention has been described in reference to specific embodiments it should be understood by those skilled in the art that various changes can be made and equivalents may be substituted without departing from the true spirit and scope of the invention. All such modifications are intended to be within the scope of the claims appended hereto.

The embodiments of the invention in which an exclusive property or privilege is claimed are as follows:

1. An organopolysiloxane rubber composition for use as an anti-corrosion, cathodic protection coating on surfaces, the composition consisting essentially of the product which is obtained by mixing the following:
a) from about 5 to about 80 weight percent of one or more polyorganosiloxane fluids of the formula:
R¹[(R)₂SiO]n(R)₂Si R¹
in which R is a monovalent alkyl or alkenyl radical having 1 to 8 carbon atoms or a phenyl radical, R¹ each of which may be the same or different are OH, or a monovalent alkyl or alkenyl radical having 1 to 8 carbon atoms or a phenyl radical, and n has an average value such that the viscosity is from about 10 to about 100,000 centipoise at 25° C., in at least one of the polyorganosiloxane fluids R¹ is a reactive group selected from OH and alkenyl;
b) from about 10 to about 80 weight percent of a sacrificial metal filler;
c) from about 0 to about 15 weight percent of a conductive filler;
d) a suitable catalyst for the reactive group of the polyorganosiloxane of (a); and
e) a suitable cross linking agent for the reactive group of the polyorganosiloxane of (a).

2. A composition according to claim 1 consisting essentially of:
a) from about 5 to about 80 weight percent of one or more polydiorganosiloxane fluids of the formula:
HO[(R¹⁷)₂SiO]ₙ(R¹⁷)₂SiOH
in which R¹⁷ is a monovalent alkyl or alkenyl radical having 1 to 8 carbon atoms or a phenyl radical, which may contain 3 to 9 halogen atoms, and n has an average value such that the viscosity is from about 10 to about 100,000 centipoise at 25° C.;
b) from 0 to about 8 weight percent of a bifunctional chain extender of the general formula:
R¹⁸₂—Si—X¹₂
where X¹ is alkoxy or ketoximino and R¹⁸ is a monovalent alkyl or alkenyl radical having 1 to 8 carbon atoms or a phenyl radical;
c) from about 10 to about 80 weight percent of one or more sacrificial metal fillers providing cathodic protection;
d) from about 0 to about 15 weight percent of one more types of conductive fillers;
e) from 0 to about 20 weight percent of an optionally surface treated amorphous SiO₂ reinforcing filler having a surface area of between about 50 to 250 m²/g and a particle size range between about 0.01 and 0.03 microns;
f) from about 0.1 to about 35 weight percent of one or more crosslinking agents of general formula:
(X)₄₋ₘ—Si—R¹²ₘ
where R¹² is an alkyl, alkenyl or phenyl radical, X is an alkyl radical with a functional group selected from carboxyl, ketoximino, alkoxy, carbonyl or amine linked directly to the silicone atom, and m is an integer of from 0 to 2;
g) from about 0.2 to about 3 weight percent of an adhesion promoter of the formula: 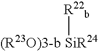
in which R²² and R²³ are independently selected from monovalent alkyl or alkenyl radicals having 1 to 8 carbon atoms or a phenyl radical which may optionally be substituted with an alkyl radical having 1 to 8 carbon atoms and may also contain 3 to 9 halogen atoms, b is an integer between 0 and 3, and R²⁴ is a saturated, unsaturated or aromatic hydrocarbon radical having 1 to 10 carbon atoms which may optionally contain an organo-functional group;
h) from about 0 to about 5 weight percent of an organometalic complex as a condensation catalyst of the formula:
(R²⁵)₂M(R²⁶)₂
where R²⁵ is monovalent alkyl or alkenyl radical having 1 to 10 carbon atoms or a phenyl radical, R²⁶ is an alkyl or alkenyl radical having 1 to 10 carbon atoms or a phenyl radical having an organo-functional group and M is a metal; and
i) from 0 to 80 weight percent of a suitable solvent or diluent.

3. A composition according to claim 2 wherein n is selected such that the viscosity is from about 1,000 to about 20,000 centipoise at 25° C.

4. A composition according to claim 3 wherein R¹⁷ is alkyl.

5. A composition according to claim 4 wherein R¹⁷ is methyl.

6. A composition according to claim 5 wherein the crosslinker is an oximosilane cross-linking agent of the formula:
R²⁰Si(ON═CR²¹₂)₃
in which R²⁰ and R²¹ are independently selected from monovalent alkyl or alkenyl radicals having 1 to 8 carbon atoms or a phenyl radical which may optionally be substituted with an alkyl radical having 1 to 8 carbon atoms.

7. A composition according to claim 6 wherein the adhesion promoter is a compound of the formula: 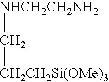
wherein Me is the methyl radical.

8. A composition according to claim 7 wherein condensation catalyst is an organotin salt of a carboxylic acid selected from the group consisting of dibutyltindiacetate, stannous octoate and dibutyltin dioctoate.

9. A composition according to claim 8 wherein the organotin salt of a carboxylic acid is a compound of the formula:
(C₄H₉)₂Sn(OCOC₁₀H₂₀CH₃)₂.

10. A composition according to claim 9 wherein the sacrificial metal filler is one or more materials selected from zinc powder, zinc flakes, nickel powder, nickel flakes, magnesium powder, magnesium flakes, aluminum powder and aluminum flakes.

11. A composition according to claim 10 wherein the conductive metal filler is one or more material selected from metal powder, metal coated glass fibers, metal flakes, carbon or graphite powder and mica.

12. A composition according to claim 11 wherein the surface of the amorphous SiO₂ reinforcing filler has been treated with hexamethyldisilazane or polydimethylsiloxane or silane.

13. A composition according to claim 12 wherein the sacrificial metal filler is zinc powder or zinc flakes, and the conductive filler is metal coated glass fiber.

14. A composition according to claim 2 consisting essentially of:
a) about 24 weight percent of a hydroxyl terminated dimethyl polysiloxane fluid having a viscosity of about 5,000 Centipoise at 25° C.;
b) about 2 weight percent of a mixture of amorphous and crystalline SiO₂ fillers having a specific gravity of 2.2 and surface area of up to about 130 m²/g;
c) about 3 weight percent of methyl tris-(methyl ethyl ketoxime)silane;
d) about 1 weight percent of N-(2 aminoethyl-3 aminopropyl)trimethoxysilane;
e) about 0.1 weight percent of dibutyltindilaurate;
f) about 50 weight percent of one or more sacrificial metal fillers selected from zinc powder, zinc flakes, aluminum powder, and aluminum flakes, and metal coated glass fibers; and
g) about 10 weight percent of metal coated glass fibers are a conductive filler; and
h) about 10 weight percent of a solvent.

15. A method of protecting a surface from corrosion and cathodic stress comprising:
(1) applying to the surface a thin layer of a one-part organopolysiloxane rubber composition consisting essentially of the product which is obtained by mixing the following:
a) from about 5 to about 80 weight percent of one or more polydiorganosiloxane fluids of the formula:
HO[(R¹⁷)₂SiO]ₙ(R¹⁷)₂SiOH
in which R¹⁷ is a monovalent alkyl or alkenyl radical having 1 to 8 carbon atoms or a phenyl radical, which may contain 3 to 9 halogen atoms, and n has an average value such that the viscosity is from about 10 to about 100,000 centipoise at 25° C.;
b) from 0 to about 8 weight percent of a bifunctional chain extender of the general formula:
R¹⁸₂—Si—X¹₂
where X¹ is alkoxy or ketoximino and R¹⁸ is a monovalent alkyl or alkenyl radical having 1 to 8 carbon atoms or a phenyl radical;
c) from about 10 to about 80 weight percent of one or more sacrificial metal fillers providing cathodic protection;
d) from about 0 to about 15 weight percent of one more conductive fillers;
e) from 0 to about 20 weight percent of an optionally surface treated amorphous SiO₂ reinforcing filler having a surface area of between about 50 to 250 m²/g and a particle size range between about 0.01 and 0.03 microns;
f) from about 0.1 to about 35 weight percent of one or more crosslinking agents of general formula:
(X)₄₋ₘ—Si—R¹²ₘ
where R¹² is an alkyl, alkenyl or phenyl radical, X is an alkyl radical with a functional group selected from carboxyl, ketoximino, alkoxy, carbonyl or amine linked directly to the silicone atom, and m is an integer of from 0 to 2;
g) from about 0.2 to about 3 weight percent of an adhesion promoter of the formula: 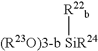
in which R²² and R²³ are independently selected from monovalent alkyl or alkenyl radicals having 1 to 8 carbon atoms or a phenyl radical which may optionally be substituted with an alkyl radical having 1 to 8 carbon atoms and may also contain 3 to 9 halogen atoms, b is an integer between 0 and 3, and R²⁴ is a saturated, unsaturated or aromatic hydrocarbon radical having 1 to 10 carbon atoms which may optionally contain an organo-functional group;
h) from about 0 to about 5 weight percent of an organometalic complex as a condensation catalyst of the formula:
(R²⁵)₂M (R²⁶)₂
where R²⁵ is monovalent alkyl or alkenyl radical having 1 to 10 carbon atoms or a phenyl radical, R²⁶ is an alkyl or alkenyl radical having 1 to 10 carbon atoms or a phenyl radical having an organo-functional group; and
i) from 0 to 80 weight percent of a suitable solvent or diluent.
(2) allowing the layer of the one-part organopolysiloxane rubber composition to cure at room temperature to a silicone elastomer.

16. A method according to claim 15 wherein n is selected such that the viscosity is from about 1,000 to about 20,000 centipoise at 25° C.

17. A method according to claim 16 wherein R¹⁷ is alkyl.

18. A method according to claim 17 wherein the sacrificial metal filler is one or more materials selected from zinc powder, zinc flakes, nickel powder, nickel flakes, magnesium powder, magnesium flakes, aluminum powder, and aluminum flakes.

19. A method according to claim 18 wherein the sacrificial metal filler is one or more materials selected from zinc powder, and zinc flakes, and the conductive filler is metal coated glass fiber.

20. A method according to claim 15 wherein the composition consists essentially of:
a) about 24 weight percent of a hydroxyl terminated dimethyl polysiloxane fluid having a viscosity of 1,000 to 5,000 Centipoise at 25° C.;
b) about 2 weight percent of a mixture of amorphous and crystalline SiO₂ fillers having a specific gravity of 2.2 and surface area of up to about 130 m²/g;
c) about 3 weight percent of methyl tris-(methyl ethyl ketoxime)silane;
d) about 1 weight percent of N-(2 aminoethyl-3 aminopropyl)trimethoxysilane;
e) about 0.1 weight percent of dibutyltindilaurate;
f) about 50 weight percent of one or more sacrificial metal fillers selected from zinc powder, zinc flakes, aluminum powder, and aluminum flakes, and metal coated glass fibers; and
g) about 10 weight percent of metal coated glass fibers are a conductive filler; and
h) about 10 weight percent of a solvent.
